(19) United States
(12) Patent Application Publication
(10) Pub. No.: US 2020/0024712 A1
(43) Pub. Date: Jan. 23, 2020

(54) DEVICE FOR PREDICTING ALUMINUM PRODUCT PROPERTIES, METHOD FOR PREDICTING ALUMINUM PRODUCT PROPERTIES, CONTROL PROGRAM, AND STORAGE MEDIUM

(71) Applicant: UACJ Corporation, Tokyo (JP)

(72) Inventor: Shingo Iwamura, Tokyo (JP)

(73) Assignees: UACJ Corporation, Tokyo (JP); UACJ Corporation, Tokyo (JP)

(21) Appl. No.: 16/337,980

(22) PCT Filed: Sep. 28, 2017
(86) PCT No.: PCT/JP2017/035248

§ 371 Date: Mar. 29, 2019

(30) Foreign Application Priority Data
Sep. 30, 2016 (JP) 2016-194723

(51) Int. Cl. C22F 1/04; B22D 2/00; G06N 3/04; G06N 3/10; G06N 3/08; B21C 23/00

(52) U.S. Cl. CPC C22F 1/04; B22D 2/006; B21C 23/002; G06N 3/10; G06N 3/08; G06N 3/04

(57) ABSTRACT

In order to contribute to optimization of manufacturing conditions under which to manufacture an aluminum product, a property predicting device includes: a data obtaining section configured to obtain a plurality of parameters indicative of manufacturing conditions under which to manufacture an aluminum product; and a neural network (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters.

### TECHNICAL FIELD

The present invention relates to, for example, an aluminum product property predicting device configured to output a property value indicative of a property of an aluminum product which has been manufactured under given manufacturing conditions.

### BACKGROUND ART

A study on a method for predicting a metallic product property has conventionally been carried out. For example, Patent Literature 1 below discloses a technique for predicting, from manufacturing conditions under which to manufacture an aluminum alloy plate and with use of a linear regression formula, a property of the aluminum alloy plate which has been manufactured under those manufacturing conditions.

### CITATION LIST

### Patent Literature

Japanese Patent Application Publication, Tokukai, No. 2002-224721 (Publication Date: Aug. 13, 2002)

### SUMMARY OF INVENTION

### Technical Problem

During manufacturing of an aluminum product, manufacturing conditions which is set in each of steps which are carried out so that a product is manufactured needs to be optimized so that a desired product property is obtained. Note, however, that an industrial manufacturing process is complicated and has many parameters to control. Thus, under the circumstances, it is difficult to develop a plan to optimize manufacturing conditions.

A method of searching for favorable manufacturing conditions by trial and error while focusing on a parameter which is judged to empirically greatly affect a property of an aluminum product is currently prevalent. According to this method, time and effort are required, and a study is carried out by selecting only a limited number of parameters among many parameters. This makes it impossible to select optimum manufacturing conditions.

In order to solve such problems, it is considered possible to not only carry out prediction with use of a linear regression formula as in, for example, Patent Literature 1 but also predict a product property from past manufacturing performance data with use of an analytical method such as multiple regression analysis, principal component analysis, or a partial least square method. Note, however, that such an analytical method is not so expressive as to be applied to a complicated industrial manufacturing process. Thus, it is about all that can be carried out by a conventional technique to clarify a trend of a parameter which has a strong influence particularly on an aluminum product property. This causes a problem of difficulty in optimization of manufacturing conditions under which to manufacture an aluminum product.

The present invention has been made in view of the problems, and an object of the present invention is to achieve, for example, an aluminum product property predicting device which is contributive to optimization of manufacturing conditions under which to manufacture an aluminum product.

### Solution to Problem

In order to attain the object, an aluminum product property predicting device in accordance with an aspect of the present invention is a property predicting device configured to output a property value indicative of a property of a product which has been manufactured under given manufacturing conditions, the property predicting device including: a data obtaining section configured to obtain a plurality of parameters indicative of manufacturing conditions under which to manufacture an aluminum product; and a neural network (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters.

In order to attain the object, an aluminum product property predicting method in accordance with an aspect of the present invention is a property predicting method which is carried out with use of a property predicting device configured to output a property value indicative of a property of an aluminum product which has been manufactured under given manufacturing conditions, the property predicting method including: a data obtaining step of obtaining a plurality of parameters indicative of manufacturing conditions under which to manufacture an aluminum product; and an outputting step of outputting a property value which has been calculated with use of a neural network (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters.

### Advantageous Effects of Invention

An aspect of the present invention is to bring about an effect of providing, for example, a property predicting device which is contributive to optimization of manufacturing conditions under which to manufacture an aluminum product.

### BRIEF DESCRIPTION OF DRAWINGS

FIG. 1 is a block diagram illustrating a configuration of a main part of a property predicting device in accordance with an embodiment of the present invention.

FIG. 2 is a view showing an example of a configuration of a neural network of the property predicting device.

FIG. 3 is a view describing a calculation method carried out in the neural network.

FIG. 4 is a flowchart showing an example of a learning process carried out with respect to the neural network.

FIG. 5 is a flowchart showing an example of an optimization process carried out with respect to the neural network.

FIG. 6 is a flowchart showing an example of a property predicting process carried out by the property predicting device.

FIG. 7 is a view showing parameters used in Example 1 of the present invention.

FIG. 8 is a view showing parameters used in Example 4 of the present invention.

FIG. 9 is a contour drawing showing a change in tensile strength which change occurs in a case where a manganese content and an iron content in an aluminum product are changed.

### DESCRIPTION OF EMBODIMENTS

[Device Configuration]

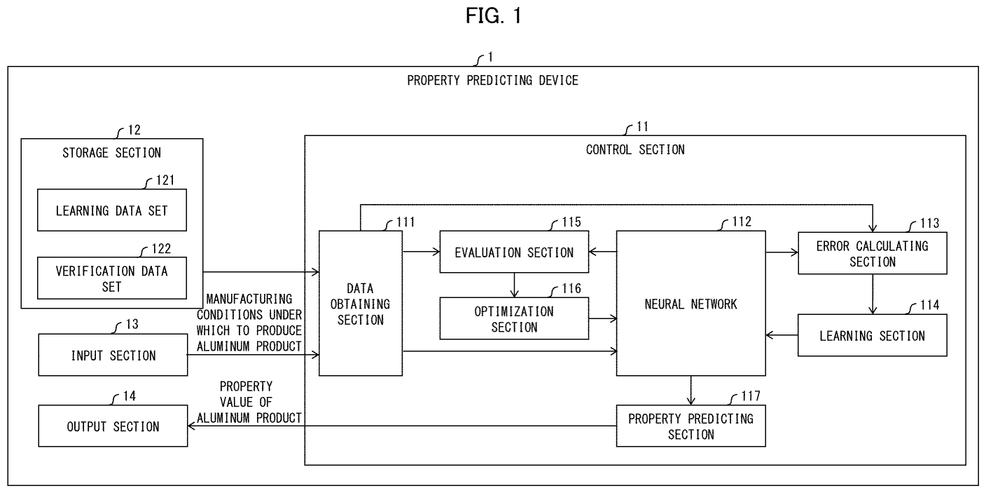

A property predicting device 1 in accordance with the present embodiment is described below with reference to FIG. 1. FIG. 1 is a block diagram illustrating a configuration of a main part of the property predicting device 1. The property predicting device 1 is configured to (i) receive, as input data, manufacturing conditions under which to manufacture an aluminum product and (ii) output a parameter (hereinafter referred to as a “property value”) indicative of a predicted value of a property possessed by the aluminum product which has been manufactured under those manufacturing conditions.

The property predicting device 1 includes a control section 11 and a storage section 12. The control section 11 is configured to collectively control sections of the property predicting device 1. The storage section 12 is configured to store therein various pieces of data to be used by the control section 11. The property predicting device 1 further includes an input section 13 and an output section 14. The input section 13 is configured to receive an input operation carried out by a user with respect to the property predicting device 1. The output section 14 is configured for the property predicting device 1 to output data. Furthermore, the control section 11 includes a data obtaining section 111, a neural network 112, an error calculating section 113, a learning section 114, an evaluation section 115, an optimization section 116, and a property predicting section 117. The storage section 12 stores therein a learning data set 121 and a verification data set 122.

The data obtaining section 111 obtains a parameter to be supplied to the neural network 112. For example, in order to cause the neural network 112 to calculate a property value of an aluminum product, the data obtaining section 111 obtains a plurality of parameters indicative of manufacturing conditions under which to manufacture the aluminum product. Parameters which are obtained by the data obtaining section 111 include not only a parameter for use in prediction of a property but also a parameter included in the learning data set 121 and a parameter included in the verification data set 122. This will be specifically described later.

The neural network 112 uses an information processing model, obtained by simulating a cerebral nerve system of an animal which transmits information via a plurality of neurons, to output an output value with respect to a parameter obtained by the data obtaining section 111. This output value is a property value of an aluminum product. The neural network 112 will be specifically described later.

The error calculating section 113 and the learning section 114, each of which is directed to realize a system through which to cause the neural network 112 to carry out learning, each carry out a process related to learning carried out by the neural network 112. The evaluation section 115 and the optimization section 116, each of which is directed to realize an optimization system for optimizing a hyper parameter of the neural network 112, each carry out a process related to optimization of the neural network 112. The optimization system is dispensable. Note, however, that the property predicting device 1 preferably includes the optimization system so as to carry out prediction with high accuracy. Learning and optimization will be specifically described later.

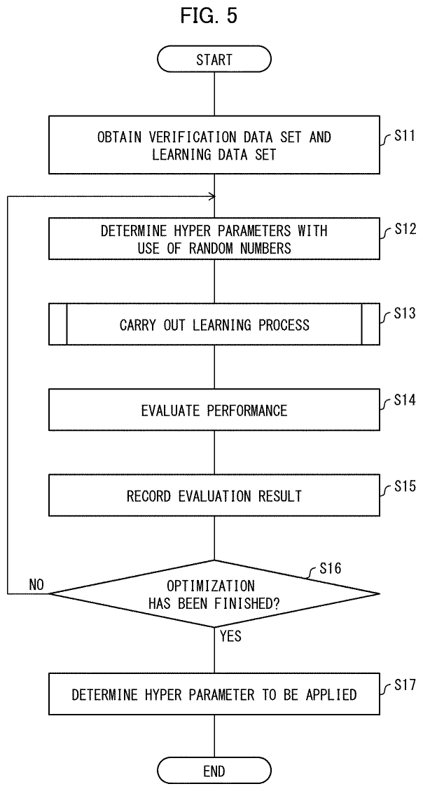

Note that a hyper parameter is one or more parameters which define a framework of property prediction calculation and learning each carried out by the neural network 112. The hyper parameter includes a hyper parameter concerned with a network structure and a hyper parameter concerned with a learning condition. Examples of the hyper parameter concerned with a network structure include the number of layers, the number of nodes of each layer, a type of activating function possessed by each node of each layer, and a type of error function possessed by each node of a final layer. Examples of the hyper parameter concerned with a learning condition include the number of times of learning and a learning rate. Examples of a method for accelerating learning include normalization of a parameter, preliminary learning, automatic adjustment of a learning rate, Momentum, and a mini batch method. Examples of a method for restraining overlearning include DropOut, L1Norm, L2Norm, and Weight Decay. In a case where such a method is applied, a parameter concerned with that method is also included in the hyper parameter. Note that the hyper parameter can be a continuous value or a discrete value. For example, it is possible to regard, as the hyper parameter, discrete information which is indicated with use of binary numbers such as 0 and 1, the discrete information being information as to whether to use a specific acceleration method. The following description assumes that the “hyper parameter” means a set of values of one or more hyper parameters. In an optimization process described later (see FIG. 5), the optimization section 116 which determines the hyper parameter determines, one after another, other one or more hyper parameters which are included in a set of values of hyper parameters and differ in value.

The property predicting section 117 causes the output section 14 to output, in a form of a property value of an aluminum product, the output value which is outputted by the neural network 112 which has been trained. For example, in a case where the output section serves as a display section configured to output information by displaying the information, the property predicting section 117 causes the output section 14 to display a property value of an aluminum product. Note that the property value can be any of a continuous value (e.g., a strength value), a discrete value (e.g., a value indicative of a quality or a grade), and a binary number of 0/1 (e.g., a value indicative of presence or absence of a defect).

The learning data set 121 is data for use in learning carried out by the neural network 112 and includes a plurality of pieces of learning data in which a plurality of parameters indicative of manufacturing conditions under which to manufacture an aluminum product and respective property values of the aluminum product manufactured under those manufacturing conditions are paired. Parameters included in a piece of learning data and property values included in the piece of learning data are identical in number but are at least partially different in value from parameters and property values of another piece of learning data. The learning data set 121 can include pieces of learning data whose pieces are higher in number than a total of the number of parameters and the number of property values. Note, however, that, in order to avoid overlearning, the learning data set 121 preferably includes a large number of pieces of learning data.

The verification data set 122 is data for use in evaluation of performance of the neural network 112 and includes a plurality of pieces of verification data in which a plurality of parameters indicative of manufacturing conditions under which to manufacture an aluminum product and respective property values of the aluminum product manufactured under those manufacturing conditions are paired. Parameters included in a piece of verification data and property values included in the piece of learning data are identical in number but are at least partially different in value from parameters and property values of another piece of learning data. As in the case of the learning data set 121, the verification data set 122 can include pieces of verification data whose pieces are higher in number than a total of the number of parameters and the number of property values. Note, however, that, in order to avoid overlearning, the verification data set 122 preferably includes a large number of pieces of verification data.

Learning data and verification data can be generated by actually manufacturing an aluminum product under given manufacturing conditions and measuring a property value of the aluminum product thus manufactured. A parameter and a property value will be specifically described later.

[Configuration of Neural Network]

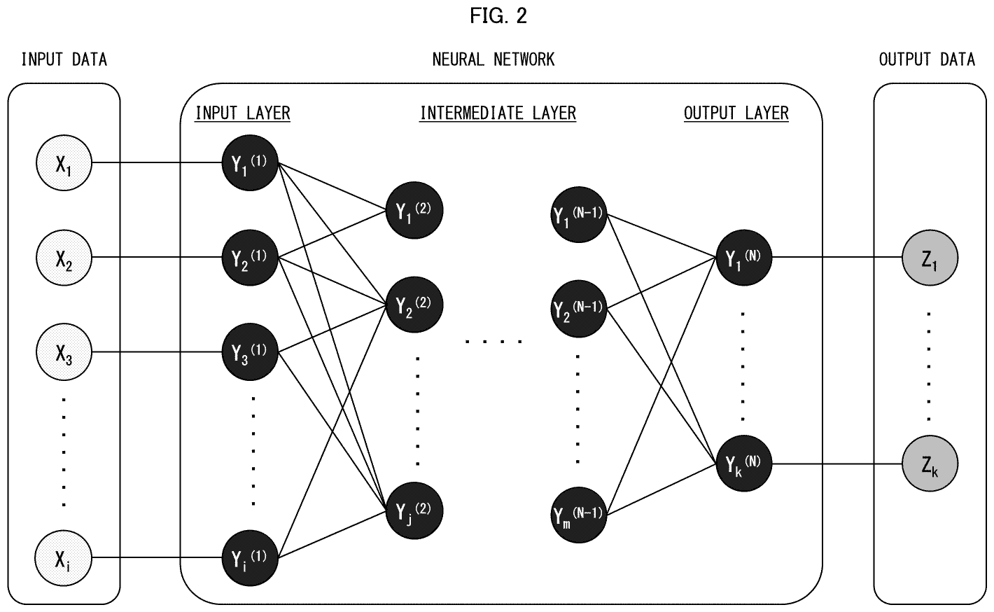

A configuration of the neural network 112 is described below with reference to FIG. 2. FIG. 2 is a view showing an example of the configuration of the neural network 112. The neural network 112 of FIG. 2 receives i pieces of input data X₁ to Xᵢ and then generates, from those pieces of input data, k pieces of output data Z₁ to Zₖ so as to output those pieces of output data. X₁ to Xᵢ are parameters indicative of manufacturing conditions under which to manufacture an aluminum product, and Z₁ to Zₖ are each a property value.

The neural network 112 of FIG. 2 is a neural network which includes N layers which are unidirectionally connected from an input layer, which is a first layer, to an output layer, which is a final layer. Each of the layers can have a bias term, which is a constant. A second layer to an (N−1)th layer out of the N layers are each an intermediate layer. Nodes constituting the input layer are identical in number to pieces of input data. Thus, the input layer is constituted by i nodes Y₁ to Yᵢ in the example of FIG. 2. Nodes constituting the output layer are identical in number to pieces of output data. Thus, the output layer is constituted by k nodes Y₁ to Yₖ in the example of FIG. 2. The example of FIG. 2 shows a plurality of intermediate layers. Note, however, that the plurality of intermediate layers can be replaced with a single intermediate layer. Each layer included in an intermediate layer is constituted by at least two nodes.

[Calculation Method Carried Out in Neural Network]

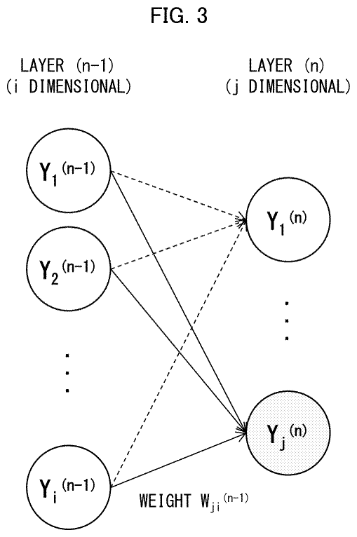

A calculation method carried out in the neural network 112 is described below with reference to FIG. 3. FIG. 3 is a view describing the calculation method carried out in the neural network 112. More specifically, FIG. 3 illustrates a layer (n−1) and a layer (n) out of a plurality of layers included in the neural network 112, and shows a calculation method carried out by a node Yj⁽ⁿ⁾ of the layer (n) out of nodes of the layer (n−1) and the layer (n).

Note that the layer (n−1) is an i-dimensional layer including i nodes and the layer (n) is a j-dimensional layer including j nodes. Note also that n≥3. To a value of each node of the first layer, i.e., the input layer, a parameter value, which is input data, can be applied as it is or by being normalized.

The node Yj⁽ⁿ⁾ obtains node values from respective i nodes belonging to the layer (n−1), which is a layer lower than the layer (n). The node values which are obtained by the node Yj⁽ⁿ⁾ are each subjected to weighting carried out with use of a weighting parameter Wji⁽ⁿ⁻¹⁾ which is set for each connection between nodes. Thus, an amount of information Aj⁽ⁿ⁾ to be received by the node Yj⁽ⁿ⁾ is defined by a linear function as expressed by an equation (1) below. A of Aj⁽ⁿ⁾ is referred to as activity.

$$\begin{matrix}[ Math . 1 ] & \\ {A}_{j}^{( n )} = {\sum }_{i = 1}^{ma x} {W}_{ij}^{( n - 1 )} {Y}_{i}^{( n - 1 )} & ( 1 )\end{matrix}$$

The activity A which is made higher causes the node Yj⁽ⁿ⁾ to have a value which is in accordance with an activating function f as expressed by an equation (2) below.

[Math. 2]

Yⱼ⁽ⁿ⁾=f(Aⱼ⁽ⁿ⁾) (2)

The activating function f can be any function that is exemplified by a sigmoid function as expressed by an equation (3) below.

$$\begin{matrix}[ Math . 3 ] & \\ f ( x ) = \frac{1}{1 + exp ( - x )} & ( 3 )\end{matrix}$$

The neural network 112 thus sequentially calculates respective node values of nodes of each of the layers from the intermediate layer to the output layer in an ascending order. This allows the neural network 112 to output values of Z₁ to Zₖ of the output layer. Since these values are each a predicted value of a property (a property value) of an aluminum product, calculation of such a value is referred to as property prediction calculation.

[Learning Carried Out by Neural Network]

The learning section 114 optimizes all weights W of the neural network 112 so that the neural network 112 can most satisfactorily describe the learning data set 121, i.e., so that a difference between a value of the output layer and a property value of learning data will be minimized.

The error calculating section 113 calculates an error (hereinafter referred to as a “learning error”) between (a) a property value which is outputted in response to supply, to the neural network 112, of a plurality of parameters included in learning data and (b) a property value included in the learning data. The error calculating section 113 can calculate, for example, a sum of square errors between these values in a form of a learning error. In this case, the learning error is expressed as an error function E(W) as expressed by an equation (4) below.

$$\begin{matrix}[ Math . 4 ] & \\ E ( W ) = \frac{1}{2} {\sum }_{k}^{ } {( {Y}_{k}^{( N )} - {Z}_{k} )}^{2} & ( 4 )\end{matrix}$$

Furthermore, in a case where parameters (in this case, Y and Z) are normalized so that the parameters each fall within a numerical range of not less than 0 and not more than 1, a learning error X (unit: %) can be expressed by an equation (5) below.

[Math. 5]

X=2×E(W)^{0.5}×100 (5)

The learning section 114 renews a weight W so as to make the learning error, which has been calculated by the error calculating section 113, smaller. To the renewal of the weight W, an error back propagation method, for example can be applied. In a case where the error back propagation method is applied and the sigmoid function is used as the activating function, an amount of correction of a weighting parameter W by the learning section 114 is expressed by an equation (6) below.

[Math. 6]

ΔWⱼᵢ⁽ⁿ⁻¹⁾=εδⱼ⁽ⁿ⁾Yⱼ⁽ⁿ⁾(1−Yⱼ⁽ⁿ⁾)Yᵢ⁽ⁿ⁻¹⁾ (6)

In the equation (6), ε represents a learning rate and can be optionally set by a designer. Furthermore, in the equation (6), δ represents an error signal. In a case where an error function which expresses a sum of square errors is used, an error signal of the output layer can be expressed as an equation (7) below, and an error signal of a layer different from the output layer can be expressed by as equation (8) below.

$$\begin{matrix}[ Math . 7 ] & \\ {δ}_{k}^{( N )} = {Y}_{k}^{( N )} - {Z}_{k} & ( 7 ) \\ [ Math . 8 ] & \\ {δ}_{j}^{( n )} = {\sum }_{i}^{ } {δ}_{k}^{( n + 1 )} {W}_{ji}^{( n )} & ( 8 )\end{matrix}$$

The learning section 114 carries out calculation described above with respect to all the weights W and renews respective values of the weights W. In a case where the calculation is repeatedly carried out, a weight W converges to an optimum value. Such a calculation procedure as described above is referred to as structural learning calculation.

[Predictable Property Value and Parameter for Predicting Property Value]

The property predicting device 1 can output property values generated during manufacturing of an aluminum product and concerned with various evaluation items. The property predicting device 1 can also output, for example, a property value concerned with a material organization of an aluminum product, a physical property value of an aluminum product, and property values such as a property value indicative of a percent defective and a property value indicative of manufacturing cost.

A property value concerned with a material organization can be a property value which is dominantly determined by a material organization and indicates, for example, a mechanical property, poor appearance caused by a coarse crystal grain (appearance quality), partial melting, anisotropy, formability, or corrosion resistance. This is because these properties are each strongly related to an organization (material organization) of aluminum. Of these properties, appearance quality can be said to be a property that is characteristic of an aluminum product. This is because an aluminum product has a use in which its beautiful appearance is utilized, as in, for example, an aluminum beverage can. Furthermore, examples of a property value different from a property value concerned with a material organization include a surface property and manufacturing cost.

Specific examples of such property values as described above include property values listed below. Note that, since it is necessary to actually measure a property value during generation of learning data, a property value is preferably easy to measure for many aluminum products.
<Property value indicative of mechanical property>: tensile strength, proof stress, fracture toughness
<Property value indicative of poor appearance>: grain size or value indicative of result of visual evaluation of surface
<Property value indicative of partial melting>: value indicative of number of surface defects, value indicative of extension (factor affected by occurrence of partial melting)
<Property value indicative of anisotropy>: ear rate, value indicative of difference in mechanical property among 0°, 45°, and 90°
<Property value indicative of formability>: value indicative of extension
<Property value indicative of corrosion resistance>: Stress Corrosion Cracking (SCC) rupture time, value indicative of Surface Water Absorption Test (SWAT) test result
<Property value indicative of surface property>: value indicative of number of surface defects
<Property value indicative of manufacturing cost>: values indicative of, for example, energy amount, time, and indirect cost each required for each step

In a case where an aluminum product is an aluminum alloy, a main contained element (alloy ingredient) and a processing heat history during each manufacturing process greatly affect a material organization of the aluminum alloy. In view of this, in order to predict a property value concerned with a material organization of an aluminum alloy, it is desirable to use, as parameters to be supplied to the neural network 112, a parameter indicative of an alloy ingredient and a parameter indicative of a processing heat history during each manufacturing process. In a case where the parameters to be supplied to the neural network 112 are limited to a parameter indicative of an alloy ingredient and a parameter indicative of a processing heat history, types of parameters can be greatly reduced. This makes it possible to achieve high-speed learning and prediction with higher accuracy.

Note that a prevalent aluminum alloy contains at least any of silicon, iron, copper, manganese, magnesium, chromium, zinc, titanium, zirconium, and nickel with respect to aluminum. Thus, a parameter group to be supplied to the neural network 112 preferably includes parameters indicative of respective amounts of these elements contained.

Furthermore, examples of a parameter indicative of a processing heat history during a manufacturing process include a parameter indicative of a temperature, a parameter indicative of a degree of processing, and a processing time. The following shows specific examples of a parameter indicative of a processing heat history which parameter can be used during a step of carrying out hot finishing rolling with use of four connected rolling machines.
First pass: (first rolling machine): [entry-side temperature, exit-side temperature, amount of change in plate thickness, rolling speed]
Second pass: (second rolling machine): [entry-side temperature, exit-side temperature, amount of change in plate thickness, rolling speed]
Third pass: (third rolling machine): [entry-side temperature, exit-side temperature, amount of change in plate thickness, rolling speed]
Fourth pass: (fourth rolling machine): [entry-side temperature, exit-side temperature, amount of change in plate thickness, rolling speed]
After rolling: [cooling rate (temperature, time)]

Note that examples of a parameter concerned with a hot finishing rolling step, the parameter not being a parameter indicative of a processing heat history, include a tension, a coil size, a coolant amount, and a reduction roll roughness. Furthermore, examples of a parameter indicative of a processing heat history during a solution heat treatment step include a rate of temperature increase, a holding temperature, a holding time, a cooling rate, and a cooling delay time.

[Examples of Aluminum Product and Manufacturing Process]

Examples of an aluminum product whose property can be predicted with use of the property predicting device 1 include an aluminum casting material, an aluminum plate material (rolled material), an aluminum foil material, an aluminum extruded material, and an aluminum forged material. Manufacturing processes for manufacturing these aluminum products include steps listed below. This makes it possible to employ, as parameters to be supplied to the neural network 112, parameters indicative of manufacturing conditions under which to carry out at least any one of steps of these manufacturing processes.
<Aluminum casting material>: dissolution step, degassing step, continuous casting step, direct chill casting step, die casting step
<Aluminum plate material (rolled material)>: dissolution step, degassing step, casting step, continuous casting step, homogenization treatment step, hot rough rolling step, hot finishing rolling step, cold rolling step, solution heat treatment step, aging treatment step, correction step, annealing step, surface treatment step
<Aluminum foil material>: dissolution step, degassing step, casting step, continuous casting step, homogenization treatment step, hot rough rolling step, hot finishing rolling step, cold rolling step, solution heat treatment step, aging treatment step, correction step, annealing step, surface treatment step, foil rolling step
<Aluminum extruded material>: dissolution step, degassing step, casting step, homogenization treatment step, hot extrusion step, drawing step, solution heat treatment step, aging treatment step, correction step, annealing step, surface treatment step, cutting step
<Aluminum forged material>: hot forging step, cold forging step, solution heat treatment step, aging treatment step, annealing step (in each of which aluminum casting material, aluminum rolled material, or aluminum extruded material is used as material)

[Example of Parameter Desirably Applied to Specific Aluminum Product]

In a case where an aluminum product whose property is to be predicted is a heat-treatable aluminum alloy, a time for which a room temperature is maintained after a solution heat treatment is preferably included in the parameters to be supplied to the neural network 112. This is because, since a heat-treatable aluminum alloy changes in strength in accordance with a room temperature after a solution heat treatment step, a time for which a room temperature is maintained after a solution heat treatment is important as a parameter. Examples of a heat-treatable aluminum alloy include an Al—Mg—Si-based alloy which is mainly used as, for example, an automobile body sheet material. Examples of the heat-treatable aluminum alloy include not only the above Al—Mg—Si-based alloy (6000 series aluminum alloy) but also an Al—Cu—Mg-based alloy (2000 series aluminum alloy) and an Al—Zn—Mg—Cu-based alloy (7000 series aluminum alloy).

Furthermore, in a case where an aluminum product whose property is to be predicted is either one of a heat-treatable aluminum alloy and a heat-treatable high-strength forged material each of which contains at least any of zirconium, chromium, and manganese, a parameter indicative of an amount of zirconium contained, a parameter indicative of a heat history (a time and/or a temperature) during a homogenization treatment, and a parameter indicative of a heat history (a time, a temperature, and/or a cooling rate) during a solution heat treatment are preferably included in the parameters to be supplied to the neural network 112. This is because an error in combination of these parameters may cause a product to have a lower strength due to, for example, unsuitability for heat treatment or production of a coarse crystal grain. Examples of a high-strength forged material include an Al—Zn—Mg—Cu-based alloy for use in, for example, an aircraft.

Moreover, in a case where an aluminum product whose property is to be predicted is high-purity aluminum having a purity of not less than 99.9%, a parameter indicative of an amount of iron contained is preferably included in the parameters to be supplied to the neural network 112. This is because high-purity aluminum may greatly change in, for example, grain size and/or appearance quality due to a slight difference, by the order of ppm, in amount of iron contained.

[Integration of Parameters]

In a case where a plurality of parameters are correlated with each other, the number of parameters can be reduced by integrating the plurality of parameters. For example, in a case where a dimension before processing and a dimension after processing are included in a parameter during some processing process, those dimensions can be integrated into a single parameter, which is a degree of processing. Such dimensional compression can be carried out based on, for example, a physical theory, an empirical rule, and a simulated calculation.

Dimensional compression allows a parameter to be replaced with a more generic concept. This is useful in theoretically and empirically understanding a result of prediction calculation. Furthermore, since the number of parameters is reduced, a learning speed is increased accordingly.

Examples of integration of a plurality of parameters into a single parameter include not only the integration of a plurality of parameters indicative of dimensions before and after processing into a single parameter, which is a degree of processing, but also such integration as described below.
<Plurality of parameters indicative of material temperature, degree of processing, size of material to be processed, and size of processing equipment>: integration into parameter indicative of amount of heat generation associated with processing and amount of heat removed from equipment
<Plurality of parameters indicative of alloy ingredient, temperature, and time>: integration into parameter indicative of solid solubility and dispersion state (number, size, and/or volume ratio) of deposits
<Plurality of parameters indicative of dispersion state of deposits> integration into parameter indicative of recrystallization restraining power
<Plurality of parameters indicative of degree of processing> integration into parameter, which is dislocation density
<Plurality of parameters indicative of dislocation density, recrystallization restraining power, temperature, and time>: integration into parameter, which is recrystallization rate

An industrial manufacturing process is complicated, and it is ordinarily not easy to find such relationships as described above. Note, however, that use of the property predicting device 1 makes it possible to find those relationships.

[Learning Process]

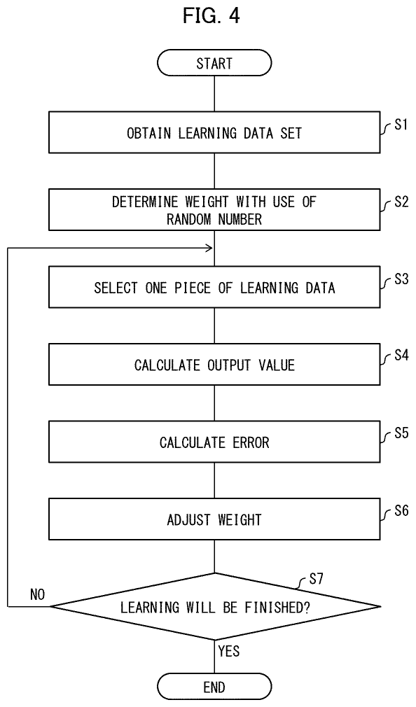

A learning process carried out by the property predicting device 1 is described below with reference to FIG. 4. FIG. 4 is a flowchart showing an example of a learning process.

First, the data obtaining section 111obtains the learning data set 121 which is stored in the storage section 12 (S1). Note that, in a case where there are hyper parameters that have not been set, those hyper parameters can also be obtained so as to be applied to the neural network 112. The hyper parameters can be inputted by a user via, for example, the input section 13.

Next, the learning section 114 determines a weight W of the neural network 112 with use of a random number (S2) and applies the weight W thus determined to the neural network 112. Note that a method of determining an initial value of the weight W is not limited to the above example.

Subsequently, the data obtaining section 111 selects a piece of learning data out of the learning data set 121 obtained (S3), and supplies, to the input layer of the neural network 112, each parameter of the selected piece of learning data. Thus, the neural network 112 calculates an output value from the each parameter supplied thereto (S4).

Then, the error calculating section 113 calculates an error (learning error) between (a) the output value which has been calculated by the neural network 112 and (b) a property value included in the learning data which has been selected in S3 (S5). Thereafter, the learning section 114 adjusts the weight W so that the error which has been calculated in S5 is minimized (S6).

Next, the learning section 114 determines whether learning will be finished (S7). In a case where the learning section 114 determines that learning will be finished (YES in S7), the learning process is finished. This results in a state in which the neural network 112 has been trained. Meanwhile, in a case where the learning section 114 determines that learning will not be finished (NO in S7), the process returns to S3. In carrying out the step S3 for second and later times, the data obtaining section 111selects an unselected piece of learning data out of the learning data set 121 obtained. Then, the steps S4 to S7 are carried out again with use of that piece of learning data. That is, according to the learning process, until it is determined in S7 that learning will be finished, a process for adjusting a weighting parameter is repeatedly carried out while learning data is changed.

Note that, for example, in a case where the number of times of learning (the number of times a series of steps S3 to S6 is carried out) reaches a given number of times, the learning section 114 can determine in S7 that learning will be finished. Note also that, for example, in a case where an evaluation value of the neural network 112 which evaluation value has been calculated by the evaluation section 115 reaches a target value, the learning section 114 can determine in S7 that learning will be finished. Specifically, it is possible to (i) use verification data to cause the evaluation section 115 to calculate a verification error and (ii) determine, in accordance with a value of the verification error, whether learning will be finished. The neural network 112 which is in an overlearning state makes a verification error great even if a learning error is small. That is, according to the neural network 112 which is high in prediction accuracy, a learning error and a verification error each have a small value. Thus, in a case where learning is carried out until a verification error has a value which is not more than a target value, the neural network 112 can improve in prediction accuracy.

[Optimization Process]

An optimum hyper parameter varies in accordance with a data set for use in, for example, learning. Thus, in order to cause the property predicting device 1 to exhibit highly accurate prediction performance, it is necessary to optimize a hyper parameter. The following description discusses, with reference to FIG. 5, an optimization process carried out by the property predicting device 1. FIG. 5 is a flowchart showing an example of an optimization process.

First, the data obtaining section 111 obtains the verification data set 122 and the learning data set 121 each of which is stored in the storage section 12 (S11). Next, the optimization section 116 determines hyper parameters of the neural network 112 with use of random numbers (S12), and applies the hyper parameters thus determined to the neural network 112. Note that a user can specify a range of a hyper parameter. In a case where the range is specified, the optimization section 116 determines a hyper parameter within the range. Note also that a method of determining an initial value of a hyper parameter is not limited to the above example.

Subsequently, the data obtaining section 111, the error calculating section 113, and the learning section 114 each carry out the learning process shown in FIG. 4 (S13). This results in a state in which the neural network 112 to which the each hyper parameter determined in S12 was applied has been trained.

Then, the evaluation section 115 evaluates performance of the neural network 112 which has been trained (S14), and records an evaluation result in the storage section 12 (S15). Specifically, the evaluation section 115 (i) supplies, to the input layer of the neural network 112, each parameter of the verification data which is included in the verification data set 122, and (ii) causes the neural network 112 to calculate an output value. Thereafter, the evaluation section 115 (i) calculates an error (verification error) between (a) the output value which has been calculated by the neural network 112 and (b) a property value included in the verification data, and (ii) records, in a form of an evaluation value of the neural network 112, the error calculated. Furthermore, the evaluation section 115 can also record a value of a learning error which value is obtained when the neural network 112 finishes learning.

In a case where D pieces of verification data are supplied to the input layer, an error E0 is expressed by, for example, an equation (9) below. Note that K in the equation (9) represents the number of property values to be predicted. Note also that a verification error can also be expressed as a percentage. In this case, by normalizing a parameter so that the parameter falls within a numerical range of not less than 0 and not more than 1, a verification error of 2×E00^{.5}×100 is obtained.

$$\begin{matrix}[ Math . 9 ] & \\ E 0 = \frac{{\sum }_{d = 1}^{D} \sqrt{\frac{{E}_{d}}{{K}_{d}}}}{D} & ( 9 )\end{matrix}$$

Next, the optimization section 116 determines whether optimization of the hyper parameters of the neural network 112 has been finished (S16). The optimization section 116 which determines that the optimization has been finished (YES in S16) determines a hyper parameter to be applied to the neural network 112 (S17), and finishes the optimization process. The hyper parameter to be applied is a hyper parameter whose evaluation result recorded in S15 was the most favorable, i.e., whose verification error (in a case where a learning error is also recorded, both the verification error and the learning error) was/were the smallest. This results in a state in which the neural network 112 has been optimized.

Meanwhile, in a case where the optimization section 116 which determines that the optimization has not been finished (NO in S16), the process returns to S12, and the steps S12 to S16 are carried out again. Note that in carrying out the step S14 for second and later times, the evaluation section 115 carries out performance evaluation with use of an unselected piece of verification data out of the verification data which is included in the verification data set 122. The optimization process is thus carried out by repeatedly carrying out, until it is determined in S16 that the optimization has been finished, a series of steps in which hyper parameters are determined, the neural network 112 to which those hyper parameters have been applied carries out learning, performance of the neural network 112 which has been trained is evaluated, and a result of the evaluation is recorded. The optimization section 116 determines a plurality of kinds of hyper parameters while the above series of steps is being repeatedly carried out. The evaluation section 115 evaluates, for each of the hyper parameters which have been determined by the optimization section 116in S12, performance of the neural network 112 which has been trained. By using, as an evaluation result, an evaluation value which has been calculated in accordance with a given criterion, the evaluation section 115 can evaluate performance of the neural network 112 which has been trained.

For example, in a case where the number of times of processing (the number of times a series of steps S12 to S16 is carried out) reaches a given number of times, the optimization section 116 can determine in S16 that the optimization has been finished. Alternatively, for example, in a case where the evaluation value which has been calculated by the evaluation section 115 reaches the target value, the optimization section 116can determine in S16 that the optimization has been finished.

Furthermore, in carrying out the step S12 for second and later times, the optimization section 116 can use a probability density function to determine hyper parameters which are more favorable than hyper parameters determined by random numbers. The probability density function can be generated based on the verification error which has been calculated during the performance evaluation in S14. The probability density function can be a function in any form provided that the function returns a great value in a case where the verification error is in a small numerical range, whereas the function returns a small value in a case where the verification error is in a great numerical range. For example, the probability density function can be a reciprocal of the verification error.

As described above, the optimization section 116 determines a plurality of kinds of hyper parameters of the neural network 112 and determines, by comparing evaluation values each indicating performance of the neural network 122, the performance corresponding to each of values of the hyper parameters determined, a hyper parameter to be used to predict a property value. Thus, it is possible to apply, to the neural network 112, a hyper parameter which makes it possible to further improve performance of the neural network 112.

[Property Predicting Process]

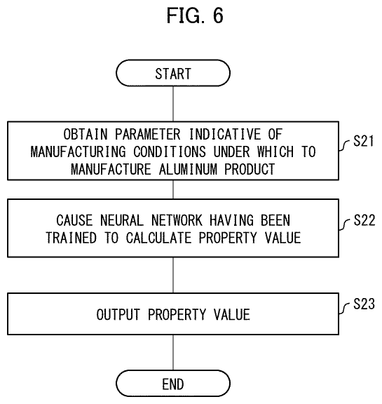

A property predicting process (property predicting method) carried out by the property predicting device 1 is described below with reference to FIG. 6. FIG. 6 is a flowchart showing an example of a property predicting process. Note that the neural network 112 which is to be used to carry out the property predicting process has finished at least learning through the process shown in FIG. 4 or FIG. 5.

First, a user supplies, to the property predicting device 1 via the input section 13, parameters indicative of manufacturing conditions under which to manufacture an aluminum product. The data obtaining section 111 obtains that parameter (S21, a data obtaining step) and supplies the parameter to the neural network 112.

Next, the neural network 112 uses the parameter, which has been obtained in S21, to calculate a property value of the aluminum product which has been manufactured under the above manufacturing conditions (S22). Then, the property predicting section 117 causes the output section 14 to output the property value which has been calculated in S22 (S23, an outputting step).

[Trend Search (One-Dimensional or Two-Dimensional)]

The property predicting device 1 can also output data indicating how a property value changes in a case where parameters indicative of a condition under which to manufacture an aluminum product partially change. In this case, the data obtaining section 111 not only receives an input of the parameters indicative of a condition under which to manufacture an aluminum product but also receives specification of a parameter to be changed (hereinafter referred to as a “target parameter”). Furthermore, the data obtaining section 111 receives specification of a range within which to change a parameter (an upper limit and a lower limit).

Next, the data obtaining section 111 selects a plurality of values of the target parameter in the above range. For example, the data obtaining section 111 can separate the range into a plurality of parts at regular intervals and select a value at each separation. This allows values to be equally selected from the range. Then, the data obtaining section 111 supplies, to the neural network 112, a parameter group including the target parameter having the values selected, and causes a property value to be outputted. In a case where the above process is carried out with respect to each of the values selected, data indicating how a property value changes can be outputted in accordance with a change in target parameter. Note that parameters different from the target parameter each have an unchanged value in each step of a trend search process. Each of those parameters can be a representative value such as an average value or a median.

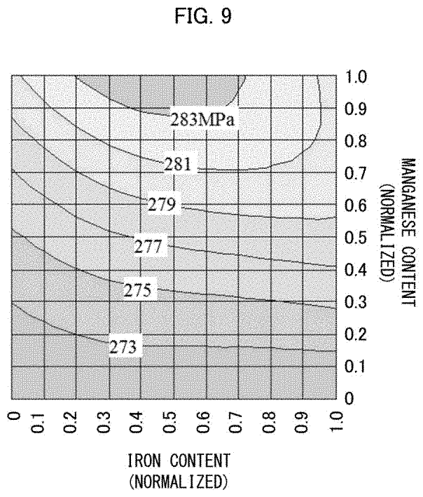

In order to output data indicating how a property value changes in accordance with a change in a single target parameter, the property predicting section 117 can cause the output section 14 to output the data by generating a scatter diagram which is obtained by plotting a pair of a value of a target parameter and a property value on a plane of coordinates. Alternatively, in order to output data indicating how a property value changes in accordance with a change in two target parameters, the property predicting section 117 can cause the output section 14 to output the data by preparing such a contour drawing as shown in FIG. 9 (described later).

[Condition Search (Multidimensional)]

The property predicting device 1 can also search for manufacturing conditions which achieve a product property which has been set by a user. In this case, the data obtaining section 111 receives an input of a condition of a property value.

Next, the data obtaining section 111 determines, with use of a random number, a value of a parameter to be supplied to the neural network 112. In this case, the data obtaining section 111 preferably determines a value falling within a range of a parameter of the learning data set 121. Subsequently, the neural network 112 calculates a property value from the value of the parameter which value has been determined by the data obtaining section 111. Then, the property predicting section 117 (i) determines whether the property value thus calculated satisfies the condition inputted and (ii) records a result of the determination.

Each of steps of a condition search process which steps are described in the above paragraphs (i.e., paragraphs [0079] and [0080]) is repeatedly carried out until a given termination condition is satisfied, and the condition search process is terminated when that termination condition is satisfied. A termination condition can be freely set. The termination condition can be, for example, a condition that each of the steps has been carried out a given number of times, or a condition that a parameter value which satisfies a condition has been calculated. Then, the property predicting section 117 causes the output section 14 to output a result of condition search. For example, the property predicting section 117 can cause the output section 14 to output a parameter value which satisfies a condition. This makes it possible to specify manufacturing conditions which achieve a product property which is desired by a user. Furthermore, in a case where a plurality of pairs of parameter values which pairs each satisfy a condition, it is also possible to specify a trend of manufacturing conditions which achieve such a product property.

Note that the property predicting device 1 can carry out not only the property predicting process shown in FIG. 6, the trend search, and the condition search, but also various prediction calculations.

[Reliability Calculation]

A result of learning carried out by the neural network 112 is obtained from a value which falls within a certain range of the learning data set 121. This prevents the neural network 112 from carrying out a prediction for a value which is far beyond that certain range. Thus, in a case where calculation is carried out, as in, for example, [Trend search] (described earlier), with use of a parameter which has been selected from a range from a minimum value to a maximum value, a parameter which is outside the learning data set 121 may be selected, so that a less reliable property value may be outputted.

In view of the above, the property predicting device 1 can include an evaluation section which (i) determines how far a parameter used for calculation is beyond a parameter included in the learning data set 121 and (ii) evaluates, in accordance with a result of the determination, reliability of a property value to be outputted by the neural network 112. Reliability can be evaluated by, for example, the following method.

First, the learning data set 121 is subjected to cluster analysis so as to be grouped for each of a given number of parameters of typical manufacturing conditions. Next, a degree to which a parameter group to be used for prediction calculation is deviated from a parameter group of each group is quantified. The degree is given by, for example, an average of square errors for each parameter. Then, a value indicative of the smallest degree of deviation is regarded as reliability.

It is possible to evaluate reliability while inputting parameters of manufacturing conditions so as to output a property value. With the configuration, in a case where the parameter inputted is less reliable, it is possible to nullify a calculated property value and output a property value in addition to a notification that the parameter inputted is less reliable.

[System Implementation Example]

A property predicting system in which a device which is different from the property predicting device 1 and can communicate with the property predicting device 1 has part of functions of the property predicting device 1 also allows functions similar to the functions of the property predicting device 1. For example, it is possible to (i) provide a neural network in a server which can communicate with the property predicting device 1 and (ii) cause the server to carry out calculation by the neural network. In this case, the property predicting device 1 needs to include the neural network 112. Alternatively, for example, it is possible to (i) provide the error calculating section 113 and the learning section 114 in a server which can communicate with the property predicting device 1 and (ii) cause the server to carry out the learning process. Similarly, it is possible to (i) provide the evaluation section 115 and the optimization section 116 in a server which can communicate with the property predicting device 1 and (ii) cause the server to carry out the optimization process.

[Software Implementation Example]

A control block of the property predicting device 1 (particularly, the control section 11) can be realized by a logic circuit (hardware) provided in an integrated circuit (IC chip) or the like or can be alternatively realized by software with use of a CPU (Central Processing Unit).

In the latter case, the property predicting device 1 includes a CPU that executes instructions of a program that is software realizing the foregoing functions; a read only memory (ROM) or a storage device (each referred to as a “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

The present invention is not limited to the embodiments, but can be altered by a skilled person in the art within the scope of the claims. The present invention also encompasses, in its technical scope, any embodiment derived by combining technical means disclosed in differing embodiments.

### Example 1

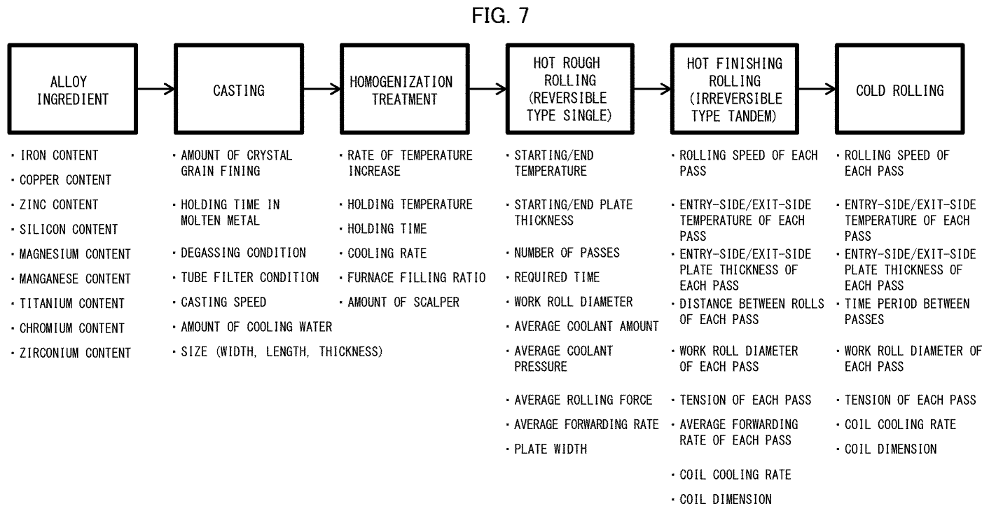

An Example of the present invention is described below with reference to FIG. 7. FIG. 7 is a view showing parameters used in Example 1 of the present invention. An aluminum product used in Example 1 is a 3000 series aluminum alloy thin plate material. As shown in FIG. 7, the aluminum product is manufactured through a casting step (direct chill forging), a homogenization treatment step, a hot rough rolling step (carried out with use of a reversible type single rolling machine), a hot finishing rolling step (carried out with use of an irreversible type tandem rolling machine), and a cold rolling step.

The parameters used in Example 1 are parameters indicative of manufacturing conditions under which to carry out each of the above steps and parameters indicative of an alloy ingredient (contained component different from aluminum). That is, all the parameters shown in FIG. 7 were supplied to the neural network 112. Note that a predicted property value was a tensile strength of the 3000 series aluminum alloy thin plate material manufactured in the manufacturing process described earlier.

To a hyper parameter, a common value or function was applied. Specifically, a learning rate was set at 0.1, a sigmoid function was used as an activating function, and a function expressing a square error was used as an error function. Furthermore, learning was carried out 100000 times. Moreover, the neural network 112 had a three-layer structure including a single intermediate layer.

For learning and verification, manufacturing performance data as many as 3600 lots in factory manufacturing was used. Specifically, out of the 3600 lots, 2500 lots accounting for 75% of the 3600 lots was used as the learning data set 121, and 900 lots accounting for 25% of the 3600 lots was used as the verification data set 122. Furthermore, an input parameter and an output parameter were each used by being normalized for each parameter so as to have a value falling within a range of not less than 0 and not more than 1.

Under the condition described above, the neural network 112 carries out learning, and prediction accuracy (performance) of the neural network 112 which had been trained was evaluated with use of verification data. As shown in Table 1 below, the result is that a learning error (calculated based on the equation (5) described earlier) of 12.1% and a verification error (2×E00^{.5}×100 where E0 was calculated based on the equation (9) described earlier) of 14.0% were obtained. This result shows that the property predicting device 1 has sufficiently high prediction accuracy.

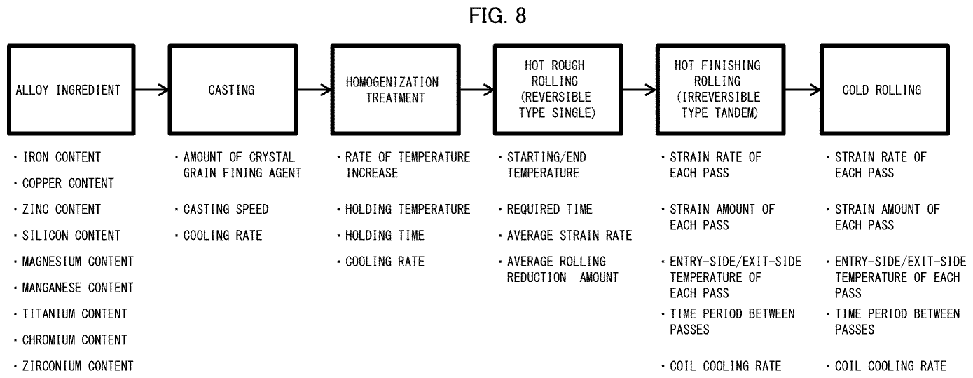

TABLE 1
Accuracy of property prediction

| | Prediction condition | | | Prediction accuracy | |
|---|---|---|---|---|---|
| | Number of | | | | Verifi- |
| | intermediate | Optimization | Input | Learning | cation |
| | layers | system | parameter | error | error |
| Ex. 1 | 1 | not used | FIG. 7 | 12.1% | 14.0% |
| Ex. 2 | 2 | not used | FIG. 7 | 10.2% | 11.5% |
| Ex. 3 | undefined | used | FIG. 7 | 9.1% | 9.8% |
| Ex. 4 | undefined | used | FIG. 8 | 3.5% | 5.6% |
| Comp. Ex. | — | — | FIG. 7 | 21.2% | 58.9% |
| (multiple | | | | | |
| regression | | | | | |
| analysis) | | | | | |

“Ex.” stands for “Example”.
“Com. Ex.” stands for “Comparative Example”.

### COMPARATIVE EXAMPLE

Comparative Example used manufacturing performance data identical to manufacturing performance data, which had been used in Example 1, to carry out property prediction by multiple regression analysis. Specifically, a multiple regression formula determined by completion of learning carried out with use of manufacturing performance data as many as 3600 lots was used to predict a tensile strength from verification data. As shown in Table 1, the result is that a learning error of 21.2% and a verification error of 58.9% were obtained. Comparative Example thus made it impossible to achieve sufficient prediction accuracy.

### Example 2

Example 2 evaluated prediction accuracy under a condition identical to the condition of Example 1 except that Example 2 caused the neural network 112 to include two intermediate layers. As shown in Table 1, the result is that a learning error of 10.2% and a verification error of 11.5% were obtained. It is revealed that Example 2 which caused the neural network 112 to include two intermediate layers (caused the entire neural network 112 to have a four-layer structure) allowed higher prediction accuracy than Example 1.

### Example 3

Example 3 evaluated prediction accuracy under a condition identical to the condition of Example 1 except that Example 3 (i) made the intermediate layer of the neural network 112 undefined and (ii) optimized a hyper parameter with use of an optimization system. A hyper parameter was searched for (a series of steps S12 to S16 of FIG. 5 was repeatedly carried out) 1000 times in the optimization system.

As shown in Table 1, the result is that a learning error of 9.1% and a verification error of 9.8% were obtained. It was determined by the optimization system that the neural network 112 included five intermediate layers (the entire neural network 112 had a seven-layer structure). Furthermore, it is revealed that Example 3 which carried out an optimization process allowed higher prediction accuracy than Example 2.

### Example 4

Unlike Examples 1 to 3, Example 4 used parameters shown in FIG. 8. These parameters are each a parameter concerned with a material organization. Furthermore, Example 4 (i) made the intermediate layer of the neural network 112 undefined and (ii) optimized a hyper parameter with use of an optimization system. As shown in Table 1, the result is that a learning error of 3.5% and a verification error of 5.6% were obtained, so that Example 4 achieved the highest prediction accuracy of all Examples. This shows that it is a great factor in achievement of high prediction accuracy how to select a parameter. Moreover, it was determined by the optimization system that the neural network 112 included four intermediate layers.

Further, Example 4 predicted a change in tensile strength in a case where a manganese content and an iron content in an aluminum product are changed after, as in Example 4, the neural network 112 of the property predicting device 1 carries out learning and is optimized. The manganese content and the iron content were changed within a range from a lower limit to an upper limit of a manufacturing instruction condition.

A result of this is show in FIG. 9. FIG. 9 is a contour drawing showing a change in tensile strength in a case where a manganese content and an iron content in an aluminum product are changed. In the contour drawing, a vertical axis shows a value in a numerical range of not less than 0 and not more than 1 by normalizing the manganese content, and a horizontal axis shows a value in a numerical range of not less than 0 and not more than 1 by normalizing the iron content. Use of such a contour drawing makes it possible to specify how to set a manganese content and an iron content so as to manufacture an aluminum product which has a desired tensile strength.

[Recap]

An aluminum product property predicting device in accordance with an aspect of the present invention is a property predicting device 1 configured to output a property value indicative of a property of a product which has been manufactured under given manufacturing conditions, the property predicting device including: a data obtaining section 111 configured to obtain a plurality of parameters indicative of manufacturing conditions under which to manufacture an aluminum product; and a neural network 112 (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters. Note that the property value can be any of a continuous value (e.g., a strength value), a discrete value (e.g., a value indicative of a quality or a grade), and a binary number of 0/1 (e.g., a value indicative of presence or absence of a defect).

With the configuration, a plurality of parameters indicative of manufacturing conditions under which to manufacture an aluminum product are obtained. Furthermore, the configuration causes a neural network to (a) receive the plurality of parameters as input data supplied to the input layer and (b) supply, from the output layer, a property value of the aluminum product which has been manufactured under the manufacturing conditions indicated by the plurality of parameters.

The neural network is expressive enough to be applied to a complicated industrial manufacturing process. Thus, the configuration makes it possible to predict, with high accuracy, a property value of the aluminum product which has been manufactured under the manufacturing conditions indicated by the plurality of parameters. Furthermore, the property predicting device makes it possible to predict a property value of an aluminum product without the need to actually manufacture the aluminum product under the manufacturing conditions indicated by the plurality of parameters obtained by the data obtaining section. Thus, the property predicting device is extremely useful in optimizing manufacturing conditions under which to manufacture an aluminum product. Note that there is no conventional example in which a neural network is applied to prediction of a property of an aluminum product and no method of utilizing a neural network for predicting a property of an aluminum product has been conventionally established.

A property predicting device can be configured to further include: an optimization section 116 configured to determine a plurality of kinds of hyper parameters of the neural network and determine, by comparing evaluation values each indicating performance of the neural network, the performance corresponding to each of values of the hyper parameters determined, a hyper parameter to be used to predict a property value.

With the configuration, a hyper parameter to be used to predict a property value is determined by comparing evaluation values based on a plurality of kinds of hyper parameters. Thus, as compared with a case where an identical hyper parameter is used at all times, the configuration allows a further improvement in performance of a neural network. This makes it possible to predict a property of an aluminum product with higher accuracy.

The aluminum product property predicting device can be configured such that: the aluminum product is any of an aluminum casting material, an aluminum rolled material, an aluminum foil material, an aluminum extruded material, and an aluminum forged material; in a case where the aluminum product is an aluminum casting material, the plurality of parameters include parameters indicative of manufacturing conditions under which to carry out at least any of a dissolution step, a degassing step, a continuous casting step, a direct chill casting step, and a die casting step; in a case where the aluminum product is an aluminum rolled material, the plurality of parameters include parameters indicative of manufacturing conditions under which to carry out at least any of a dissolution step, a degassing step, a casting step, a continuous casting step, a homogenization treatment step, a hot rough rolling step, a hot finishing rolling step, a cold rolling step, a solution heat treatment step, an aging treatment step, a correction step, an annealing step, and a surface treatment step; in a case where the aluminum product is an aluminum foil material, the plurality of parameters include parameters indicative of manufacturing conditions under which to carry out at least any of a dissolution step, a degassing step, a casting step, a continuous casting step, a homogenization treatment step, a hot rough rolling step, a hot finishing rolling step, a cold rolling step, a solution heat treatment step, an aging treatment step, a correction step, an annealing step, a surface treatment step, and a foil rolling step; in a case where the aluminum product is an aluminum extruded material, the plurality of parameters include parameters indicative of manufacturing conditions under which to carry out at least any of a dissolution step, a degassing step, a casting step, a homogenization treatment step, a hot extrusion step, a drawing step, a solution heat treatment step, an aging treatment step, a correction step, an annealing step, a surface treatment step, and a cutting step; and in a case where the aluminum product is an aluminum forged material, the plurality of parameters include parameters indicative of manufacturing conditions under which to carry out at least any of a hot forging step, a cold forging step, a solution heat treatment step, an aging treatment step, and an annealing step in each of which an aluminum casting material, an aluminum rolled material, or an aluminum extruded material is used as a material.

The configuration makes it possible to predict a property value of any of an aluminum casting material, an aluminum rolled material, an aluminum foil material, an aluminum extruded material, and an aluminum forged material.

The aluminum product property predicting device can be configured such that: the plurality of parameters include: a parameter indicative of an amount in which at least any of iron, silicon, zinc, copper, magnesium, manganese, chromium, titanium, nickel, and zirconium is contained in the aluminum product; and a parameter indicative of a processing heat history during a process for manufacturing the aluminum product; and the property value is a property value which is dominantly determined by a material organization of the aluminum product.

This makes it possible to predict, with high accuracy, a property value which is dominantly determined by a material organization of an aluminum product. This is because a main contained element and a processing heat history during each manufacturing process are each a factor which greatly affects a material organization of an aluminum product.

The aluminum product property predicting device can be configured such that: the aluminum product is a heat-treatable aluminum alloy; and the plurality of parameters include a parameter indicative of a time for which a room temperature is maintained after a solution heat treatment.

The configuration makes it possible to predict a property of a heat-treatable aluminum alloy with high accuracy. This is because, since a heat-treatable aluminum alloy changes in strength in accordance with a room temperature after a solution heat treatment step, a time for which a room temperature is maintained after a solution heat treatment is important as a parameter.

The aluminum product property predicting device can be configured such that: the aluminum product is either one of a heat-treatable aluminum alloy and a heat-treatable high-strength forged material each of which contains at least any of zirconium, chromium, and manganese; and the plurality of parameters include a parameter indicative of an amount of zirconium contained in the aluminum product, a parameter indicative of a heat history during a homogenization treatment, and a parameter indicative of a heat history during a solution heat treatment.

The configuration allows contribution to optimization of a process for manufacturing a heat-treatable aluminum alloy and a heat-treatable high-strength forged material each of which has a necessary strength and contains at least any of zirconium, chromium, and manganese. This is because according to the above heat-treatable aluminum alloy or the above heat-treatable high-strength forged material, an error in combination of the above parameters may cause a product to have a lower strength due to unsuitability for heat treatment or production of a coarse crystal grain.

The aluminum product property predicting device can be configured such that: the aluminum product is high-purity aluminum having a purity of not less than 99.9%; and the plurality of parameters include a parameter indicative of an amount of iron contained in the aluminum product.

The configuration makes it possible to predict, with high accuracy, a property of high-purity aluminum having a purity of not less than 99.9%. This is because high-purity aluminum having a purity of not less than 99.9% may greatly change in grain size and/or appearance quality due to a slight difference, by the order of ppm, in amount of iron contained.

In order to attain the object, an aluminum product property predicting method in accordance with an aspect of the present invention is a property predicting method which is carried out with use of a property predicting device configured to output a property value indicative of a property of an aluminum product which has been manufactured under given manufacturing conditions, the property predicting method including: a data obtaining step (S21) of obtaining a plurality of parameters indicative of manufacturing conditions under which to manufacture an aluminum product; and an outputting step (S23) of outputting a property value which has been calculated with use of a neural network (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters. The property predicting method brings about working effects similar to those brought about by the property predicting device.

A property predicting device in accordance with the foregoing aspects of the present invention may be realized by a computer. The present invention therefore encompasses: a control program for the property predicting device which program causes a computer to operate as the foregoing sections (software elements) of the property predicting device so that the property predicting device can be realized by the computer; and a computer-readable storage medium storing the control program therein.

### REFERENCE SIGNS LIST

1 Property predicting device

111 Data obtaining section

112 Neural network

116 Optimization section

S21 Data obtaining step

S23 Outputting step

1. An aluminum product property predicting device configured to output a property value indicative of a property of a product which has been manufactured under given manufacturing conditions,
said aluminum product property predicting device comprising:
a data obtaining section configured to obtain a plurality of parameters indicative of manufacturing conditions under which to manufacture an aluminum product; and
a neural network (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters.

2. An aluminum product property predicting device as set forth in claim 1, further comprising: an optimization section configured to determine a plurality of kinds of hyper parameters of the neural network and determine, by comparing evaluation values each indicating performance of the neural network, the performance corresponding to each of values of the hyper parameters determined, a hyper parameter to be used to predict a property value.

3. The aluminum product property predicting device as set forth in claim 1, wherein:
the aluminum product is any of an aluminum casting material, an aluminum rolled material, an aluminum foil material, an aluminum extruded material, and an aluminum forged material;
in a case where the aluminum product is an aluminum casting material, the plurality of parameters include parameters indicative of manufacturing conditions under which to carry out at least any of a dissolution step, a degassing step, a continuous casting step, a direct chill casting step, and a die casting step;
in a case where the aluminum product is an aluminum rolled material, the plurality of parameters include parameters indicative of manufacturing conditions under which to carry out at least any of a dissolution step, a degassing step, a casting step, a continuous casting step, a homogenization treatment step, a hot rough rolling step, a hot finishing rolling step, a cold rolling step, a solution heat treatment step, an aging treatment step, a correction step, an annealing step, and a surface treatment step;
in a case where the aluminum product is an aluminum foil material, the plurality of parameters include parameters indicative of manufacturing conditions under which to carry out at least any of a dissolution step, a degassing step, a casting step, a continuous casting step, a homogenization treatment step, a hot rough rolling step, a hot finishing rolling step, a cold rolling step, a solution heat treatment step, an aging treatment step, a correction step, an annealing step, a surface treatment step, and a foil rolling step;
in a case where the aluminum product is an aluminum extruded material, the plurality of parameters include parameters indicative of manufacturing conditions under which to carry out at least any of a dissolution step, a degassing step, a casting step, a homogenization treatment step, a hot extrusion step, a drawing step, a solution heat treatment step, an aging treatment step, a correction step, an annealing step, a surface treatment step, and a cutting step; and
in a case where the aluminum product is an aluminum forged material, the plurality of parameters include parameters indicative of manufacturing conditions under which to carry out at least any of a hot forging step, a cold forging step, a solution heat treatment step, an aging treatment step, and an annealing step in each of which an aluminum casting material, an aluminum rolled material, or an aluminum extruded material is used as a material.

4. The aluminum product property predicting device as set forth in claim 1, wherein:
the plurality of parameters include:
a parameter indicative of an amount in which at least any of iron, silicon, zinc, copper, magnesium, manganese, chromium, titanium, nickel, and zirconium is contained in the aluminum product; and
a parameter indicative of a processing heat history during a process for manufacturing the aluminum product; and
the property value is a property value which is dominantly determined by a material organization of the aluminum product.

5. The aluminum product property predicting device as set forth in claim 1, wherein:
the aluminum product is a heat-treatable aluminum alloy; and
the plurality of parameters include a parameter indicative of a time for which a room temperature is maintained after a solution heat treatment.

6. The aluminum product property predicting device as set forth in claim 1, wherein:
the aluminum product is either one of a heat-treatable aluminum alloy and a heat-treatable high-strength forged material each of which contains at least any of zirconium, chromium, and manganese; and
the plurality of parameters include a parameter indicative of an amount of zirconium contained in the aluminum product, a parameter indicative of a heat history during a homogenization treatment, and a parameter indicative of a heat history during a solution heat treatment.

7. The aluminum product property predicting device as set forth in claim 1, wherein:
the aluminum product is high-purity aluminum having a purity of not less than 99.9%; and
the plurality of parameters include a parameter indicative of an amount of iron contained in the aluminum product.

8. An aluminum product property predicting method which is carried out with use of an aluminum product property predicting device configured to output a property value indicative of a property of a product which has been manufactured under given manufacturing conditions,
said aluminum product property predicting method comprising:
a data obtaining step of obtaining a plurality of parameters indicative of manufacturing conditions under which to manufacture an aluminum product; and
an outputting step of outputting a property value which has been calculated with use of a neural network (i) including an input layer, at least one intermediate layer, and an output layer and (ii) configured to (a) receive the plurality of parameters as input data supplied to the input layer and (b) supply, from the output layer, a property value of the aluminum product which has been manufactured under the manufacturing conditions indicated by the plurality of parameters.

9. (canceled)

10. A non-transitory computer-readable storage medium which stores therein a control program for causing a computer to function as an aluminum product property predicting device recited in claim 1, the control program causing the computer to function as each of the data obtaining section and the neural network.
